(19) United States
(12) Patent Application Publication
(10) Pub. No.: US 2024/0344504 A1
(43) Pub. Date: Oct. 17, 2024

(54) METHODS FOR HANDLING A LOAD, IN PARTICULAR FOR INSTALLING OR REMOVING A BLADE ON AN OFFSHORE WIND TURBINE, AND DEVICES FOR CARRYING OUT SUCH METHODS

(71) Applicant: DOLFINES, Montigny le Bretonneux (FR)

(72) Inventors: Mathieu AUPERIN, VERSAILLES (FR); Jean-Claude BOURDON, Voisins le Bretonneuix (FR); Yann LEPOUTRE, Villennes sur Seine (FR); Fabien Carl FREMONT, POISSY (FR)

(21) Appl. No.: 18/291,111

(22) PCT Filed: Jul. 8, 2022
(86) PCT No.: PCT/EP2022/069160

§ 371 Date: Jan. 22, 2024

(30) Foreign Application Priority Data
Jul. 22, 2021 (FR) FR2107966
Oct. 7, 2021 (FR) FR2110634
Nov. 26, 2021 (FR) FR2112571
Jan. 28, 2022 (FR) FR2200731

(51) Int. Cl. F03D 80/50; B63B 35/44; B63B 81/00; B66C 1/10; B66C 23/18

(52) U.S. Cl. CPC F03D 80/502; B63B 35/44; B63B 81/00; B66C 1/108; B66C 23/185; B63B 2035/446; F05B 2230/70; F05B 2230/80

(57) ABSTRACT

The invention relates to a method for handling a load, in particular a blade, of an offshore wind turbine system comprising a wind turbine, wherein a crane is temporarily mounted on the platform, the crane having a tower of which a plurality of elements can be telescoped relative to each other. The invention also relates to a crane and to devices suitable for carrying out this method.

### CROSS-REFERENCE TO RELATED APPLICATIONS

This application is a National Stage of International Application No. PCT/EP2022/069160, filed Jul. 8, 2022. The entire disclosure of the above application is incorporated herein by reference.

### TECHNICAL FIELD

The present invention relates to the field of offshore wind turbines. It relates in particular to the installation or removal of blades of such wind turbines. It also relates to the handling of heavy loads, in particular the handling of equipment of a nacelle of such a wind turbine.

### INTRODUCTION

When the seabed is shallow enough, the wind turbine can comprise a mast anchored directly in the seabed. These fixed wind turbines are generally part of a wind turbine farm and significant means are implemented to erect them, in particular to install their foundation, then position the mast and attach the turbine and its blades to it.

However, when a blade of such a wind turbine must be changed, the only known way is to use jack-ups, which are self-elevating floating platforms provided with legs and equipped with a luffing jib crane. These platforms rest on the seabed and are self-elevating thanks to their column-shaped legs. Handling a blade is very difficult and requires considerable means, in terms of both height capacity and load-carrying capacity. The same is true for heavy loads equipping a nacelle of such wind turbines, for example a generator or a gearbox. Few jack-ups offer sufficient capacities, their availability is limited and their use is extremely expensive.

Where the seabed is too deep, wind turbines are supported on floating platforms. Such a floating platform may consist of a barge or a beam structure connecting at least three floaters together. Wind turbines are generally mounted on their platforms at the quayside, in a port, then towed out to sea to their operating site.

Floating wind platforms are generally located offshore. The sea is generally so deep that neither the wind turbine nor a crane that can be used for their maintenance can rest on the seabed. Independently of each other, they suffer the effects of the swell. However, in order to attach a blade to the rotor which must support it or to install a generator in the nacelle where it must operate, a virtually static approach is necessary. This requires highly favourable, not to say exceptional, sea and wind conditions. The only known realistic solution is to bring back the wind turbine with its platform to a port where the necessary maintenance can be carried out. Nevertheless, such a solution consumes considerable time, energy and means.

The problem to be solved consists in finding a method and means to change a blade of a floating wind turbine or handle a heavy load thereon, more quickly, more easily and less expensively than the known methods.

### SUMMARY

To solve this problem, the invention proposes a method for installing or removing a blade or handling a heavy load on a wind turbine, in particular supported by a platform, in particular a floating platform, wherein a crane or a lifting device having a mast comprising a plurality of elements of which some can be telescoped relative to each other can be mounted temporarily.

A first object of the invention is a method for handling a load, in particular a blade of an offshore wind turbine system comprising a wind turbine and a platform, this wind turbine comprising a mast and a nacelle supported by the mast, the nacelle comprising a rotor having a nose and blades which extend radially from this nose, including the blade which may have to be handled, which comprises the steps of.
immobilising the nacelle and the rotor in a handling position, which does not obstruct the mounting of a crane; and,
mounting this crane on the platform of the wind turbine system;
handling the load, which may be the blade;
dismantling the crane; and,
releasing the movements of the nacelle and the rotor.

The mounting step may comprise a step of attaching a base of the crane on the platform of the wind turbine system. The method advantageously comprises the supply of a crane having a mast comprising a plurality of elements. Some of the elements can be telescoped relative to each other and the step of mounting the crane may comprise a step of telescoping its elements relative to each other.

In a method according to the invention for handling a load, for example to replace an old blade by a new one, the step of handling the load may comprise a step of removing the old blade then a step of installing the new blade. Preferably, in the handling position, the old blade is in the substantially horizontal position.

The invention also relates to a wind turbine system for the implementation of a method according to the invention, wherein the platform of the system comprises means for attaching the base of the crane thereon. The platform may comprise at least three floaters connected together by a rigid structure, in particular composed of beams, this structure acting as support for the wind turbine, the means for attaching the base of the crane being arranged at the top of one of the floaters.

The invention also relates to a crane for the implementation of a method according to the invention which comprises a base to be attached to a system according to the invention. Advantageously, the crane has a mast comprising a plurality of elements, preferably, at least some of the elements can be telescoped relative to each other.

Preferably, the crane comprises hoisting means in order to move the blade horizontally and vertically. The hoisting means may comprise a sleeve and a double jib mounted so as to slide horizontally in the sleeve and having two ends each projecting from a respective side of the sleeve, each end having a respective hoist rope. The hoisting means may alternatively comprise spreader bar means.

A second object of the invention is a method for handling a load on a wind turbine which comprises a mast rigidly attached to a seabed and a nacelle supported by this mast of the wind turbine, this nacelle comprising a rotor having blades which extend radially, comprising steps of:
supplying a self-elevating platform;
immobilising the platform near said wind turbine; then,
mounting a hoisting system on the self-elevating platform, said system comprising a mast that is substantially vertical along an axis of the system and composed of a plurality of elements and a hoisting tool attached to an upper element;
immobilising the nacelle in a position allowing said load to be handled;
raising the mast;
gripping the load;
lowering the mast; then,
releasing the movements of the nacelle and the rotor.

Thus, a method for handling or attaching or removing a blade of a wind turbine which comprises a mast rigidly attached to a seabed and a nacelle supported by this mast, this nacelle comprising a rotor having blades which extend radially, comprises steps of:
supplying a self-elevating platform;
immobilising said platform near said wind turbine;
mounting a hoisting system on the platform, the system comprising a mast that is substantially vertical along an axis of the system and composed of a plurality of elements and a hoisting tool attached to an upper element;
immobilising the nacelle in a position allowing said load to be handled;
raising the mast;
handling the blade;
lowering the mast; and,
releasing the movements of the nacelle.

Advantageously, some of the elements can be telescoped relative to each other and the step of raising the system comprises a step of telescoping these elements relative to each other.

A self-elevating platform for the implementation of a method according to the second object of the invention advantageously comprises means for attaching a base of the hoisting system thereon.

In a system implemented in a method according to the second object of the invention, the tool is attached substantially at the top of an upper mast element and forms with the mast a “T” shape.

The hoisting tool may comprise a horizontal beam mounted at the top of the upper element and forming a “T” with this element, a slide mounted so as to slide horizontally on the beam, this slide supporting seating means provided to rest a blade thereon. The blade may also be mounted so as to rotate about the axis of the system and the tool may comprise, at one end of the beam, winch means to hoist a load. Preferably, the height of the seating means can be adjusted in particular to adapt to the blade which must be placed thereon.

The hoisting means may comprise a sleeve and a double jib mounted so as to slide horizontally in this sleeve and having two ends each projecting from a respective side of the sleeve, each end having a respective hoist rope.

Advantageously, at least some of the elements forming the mast of the system can be telescoped together.

Preferably, the mast comprises a lower element forming a base designed to be attached to a platform according to the second object of the invention.

According to another embodiment, a system according to the invention may comprise a base that is fixed relative to the platform, the mast being mounted so as to rotate on the base about the axis of the system, the hoisting tool comprising a substantially horizontal beam that is rigidly arranged at the top of the upper element, a winch being attached to the lower element such that it rotates about the axis, at the same time as the mast, and, a rope connected to the winch, the system further comprising a first rope return and a second rope return, each one being arranged at a respective end of the beam such that:
the rope is substantially horizontal between the two returns;
the rope extends vertically between the winch and the first return; and,
a free end of the rope extends past the second return to suspend a load thereon.

Advantageously, the system comprises arm means to connect the mast of the system with the mast of the wind turbine, preferably at least one arm being slidably mounted on the mast of the wind turbine.

A third object of the invention is a method for handling a load for a system comprising a platform having floaters connected by a structure of beams and a wind turbine having a mast mounted on the platform, comprising:
supplying a temporary horizontal framework and installing this framework on the system, resting on the platform, and,
mounting a hoisting device on the framework.

The invention does not involve returning to the port, and only requires a relatively small boat equipped with a conventional crane for offshore purposes, having for example a capacity of a few hundred tonnes at thirty metres for a hook height of at least 50 m, advantageously equipped with a swell compensator. This type of boat is easily available and relatively inexpensive; proven techniques are used.

Preferably, the hoisting means comprise a vertical tower and, at the top of the tower, a tool for supporting the load. For example, the tool may comprise means for handling a blade for the wind turbine or crane means. Advantageously, the tower comprises elements that can be telescoped relative to each other.

Preferably, the framework is arranged such that it comprises at least two locations to mount the hoisting device thereto, one of the locations being closer to the mast of the wind turbine than the other location.

One end of the framework may comprise a trimmer joist designed to rest substantially on a peripheral wall of a floater of the platform. A leg of the mast of the wind turbine may comprise a bracket used to support one end of the framework.

One end of the framework can rest on a leg of the mast, and another end of this framework can rest on a floater.

One end of the framework can rest on a floater supporting the mast.

Alternatively, each end of the framework can rest on a respective beam of the platform.

Also, the framework advantageously has a transverse section having the shape of an inverted “U” and comprises two longitudinal girders supporting together an apron, such that the framework can be arranged on top of a catwalk of the system.

A fourth object of the invention is a tool for positioning or removing a blade of a wind turbine which comprises a spreader bar and a positioner, the spreader bar being designed to hoist the blade using a crane, the spreader bar and the positioner comprising reciprocal gripping means, the positioner comprising means for attaching it to hoisting means and means for orienting and moving the blade relative to the hoisting means.

Preferably, the reciprocal gripping means comprise reciprocal insertion means. Advantageously, the insertion means comprise two poles and sleeves to insert therein the rods of which one can be inserted before the other, preferably two rods of different lengths.

The spreader bar may comprise at least one clamp to take the blade, preferably a yard arranged longitudinally and two clamps, each at a respective longitudinal end of the yard. Each clamp may comprise a lower jaw and an upper jaw, the lower jaw being fixed relative to the yard and the upper jaw being able to move vertically, such that when the blade rests on the lower jaw, the upper jaw clamps it to hold it.

Advantageously, the positioner comprises:
means for tilting the blade about a horizontal transverse axis;
means for moving the blade longitudinally; and, preferably,
means for moving the blade transversally; and/or,
means for rotating the blade about a vertical axis.

The positioner may comprise in particular:
a base on which the spreader bar can be placed, the base comprising the means for gripping the positioner on said spreader bar;
a trolley;
a longitudinal guide; and,
a connector;
the guide being arranged at an upper end of the connector and connected to the latter by a hinge which allows the guide to tilt about a transverse horizontal axis, a tilt actuator being used to control the tilting; the trolley being mounted so as to slide longitudinally on the guide, a longitudinal actuator being used to control a longitudinal translation of the trolley relative to the guide;
the base being mounted so as to slide transversally on the trolley, a transverse actuator being used to control a transverse translation of the base relative to the trolley.

### DRAWINGS

Several embodiments of the invention will be described below, given as non-limiting examples, and referring to the attached drawings in which:

FIGS. 1 to 13 illustrate the second object of the invention.

FIG. 14 illustrates the first object of the invention.

FIGS. 15 to 24 illustrate the third object of the invention.

FIGS. 25 to 37 illustrate the fourth object of the invention.

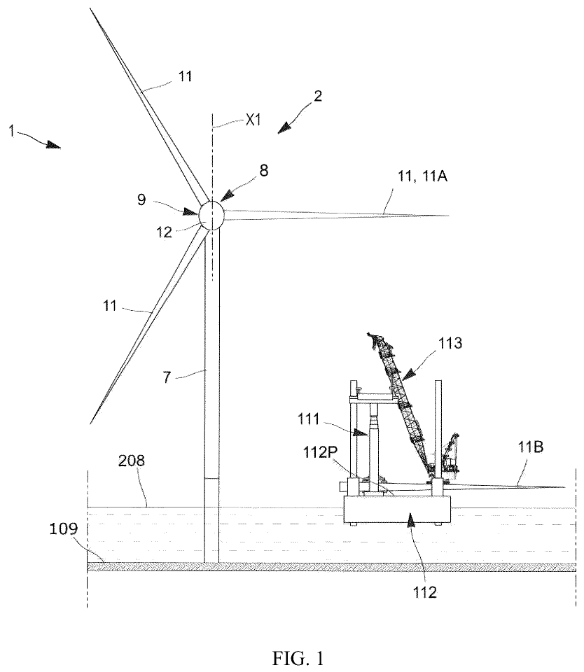

FIG. 1 is a diagrammatic elevation view of a first step of a first method according to the invention to change a damaged blade of a wind turbine using a first embodiment of a hoisting system according to the invention, step wherein a spare blade is brought onto a self-elevating platform;

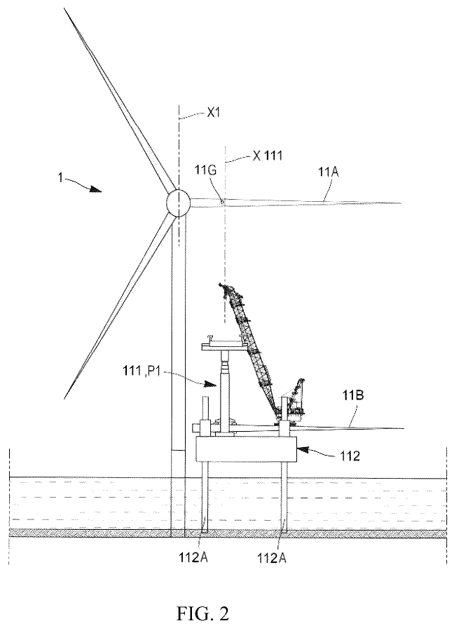

FIG. 2 is a diagrammatic view of a second step of this method, wherein the platform is installed at the foot of the wind turbine;

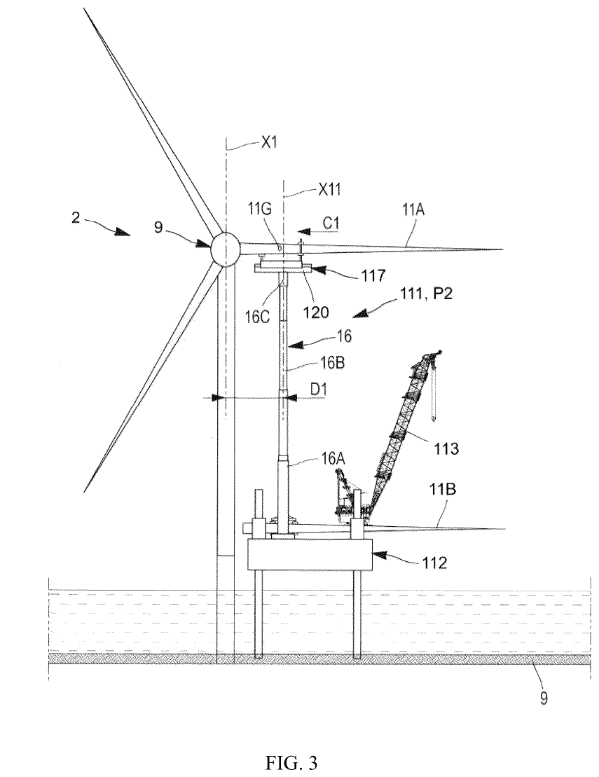

FIG. 3 is a diagrammatic view of a third step of this method, wherein the hoisting system grasps the damaged blade;

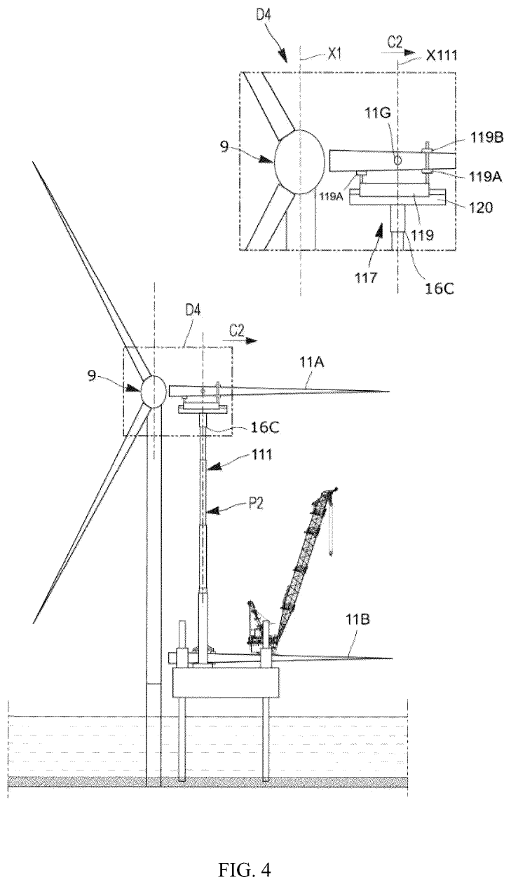

FIG. 4 is a diagrammatic view of a fourth step of this method, wherein the hoisting system uncouples the damaged blade;

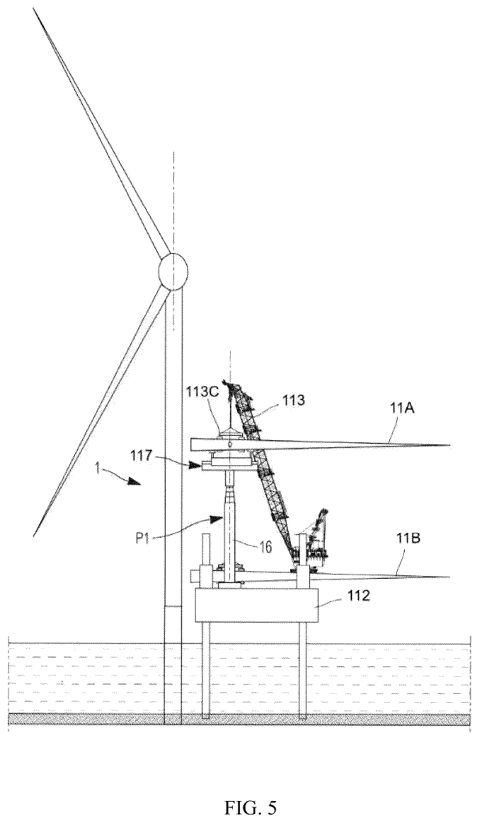

FIG. 5 is a diagrammatic view of a fifth step of this method, wherein the hoisting system lowers the damaged blade until it can be picked up by a lattice boom crane;

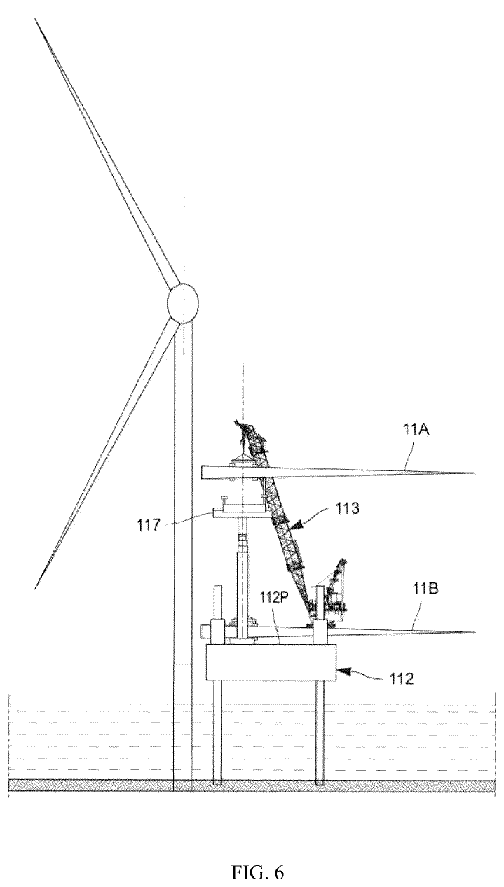

FIG. 6 is a diagrammatic view of a sixth step of this method, wherein the damaged blade is picked up by the lattice boom crane;

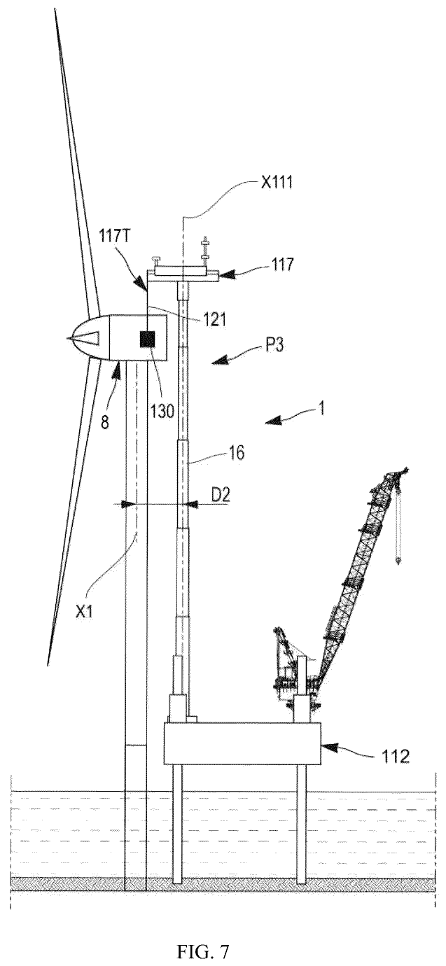

FIG. 7 is a diagrammatic view of a first step of a second method according to the invention to remove a load, in this case an item of equipment, from a nacelle of the wind turbine using the hoisting system shown on the previous figures, step wherein the system grasps the load;

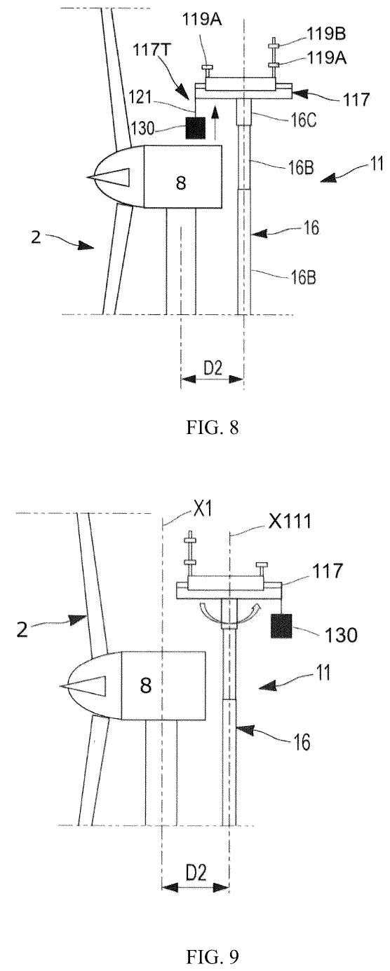

FIG. 8 is a diagrammatic view of a second step of the second method, wherein the system hoists the load;

FIG. 9 is a diagrammatic view of a third step of the second method, wherein the system orients the load;

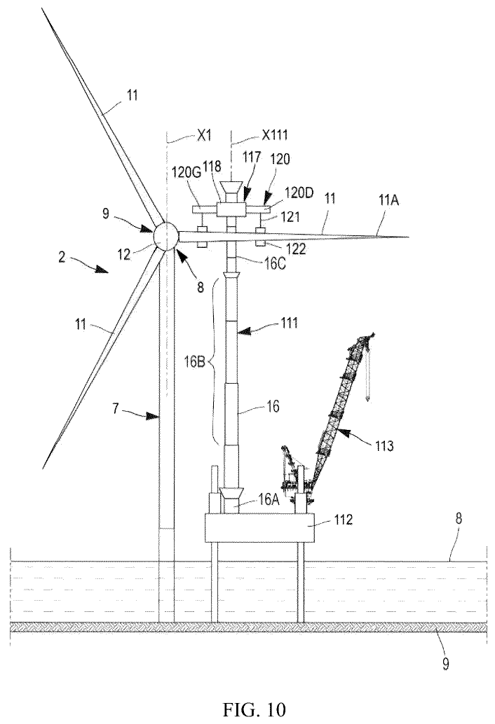

FIG. 10 is a diagrammatic elevation view of a second embodiment for a system according to the invention in the process of grasping a blade of the wind turbine; and,

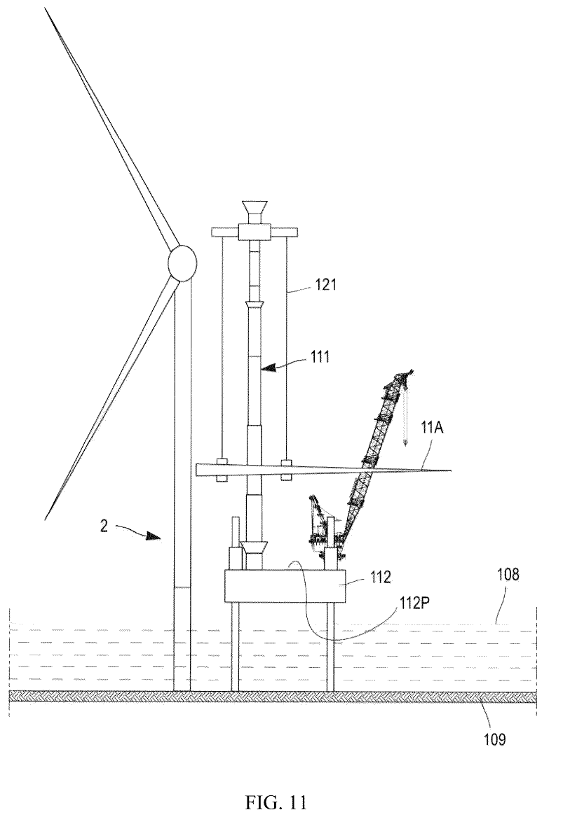

FIG. 11 is a diagrammatic view of the system of FIG. 10 in the process of lowering the blade;

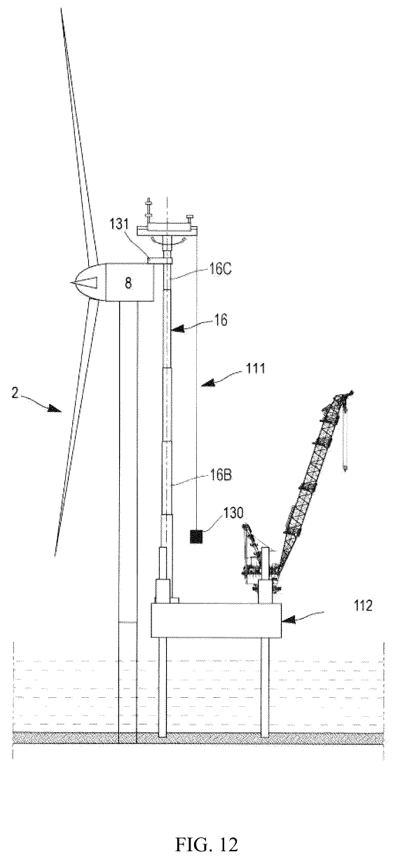

FIG. 12 is a diagrammatic view of a step of an improvement of the first embodiment of the system according to the invention as shown on FIGS. 7 to 9, in a step of removing a load; and,

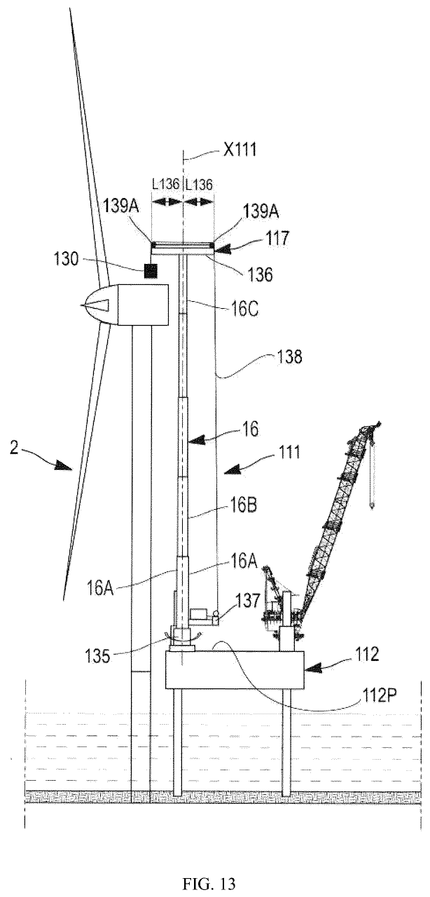

FIG. 13 is a diagrammatic view of a third embodiment for a system according to the invention, in a step of removing a load.

FIG. 14 is a diagrammatic elevation view of a crane according to the invention, mounted on a platform of a floating wind turbine, in the process of handling a blade of this wind turbine.

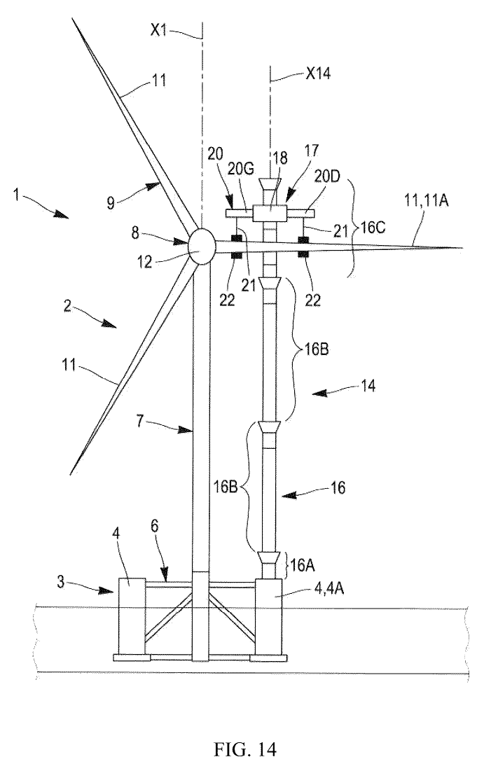

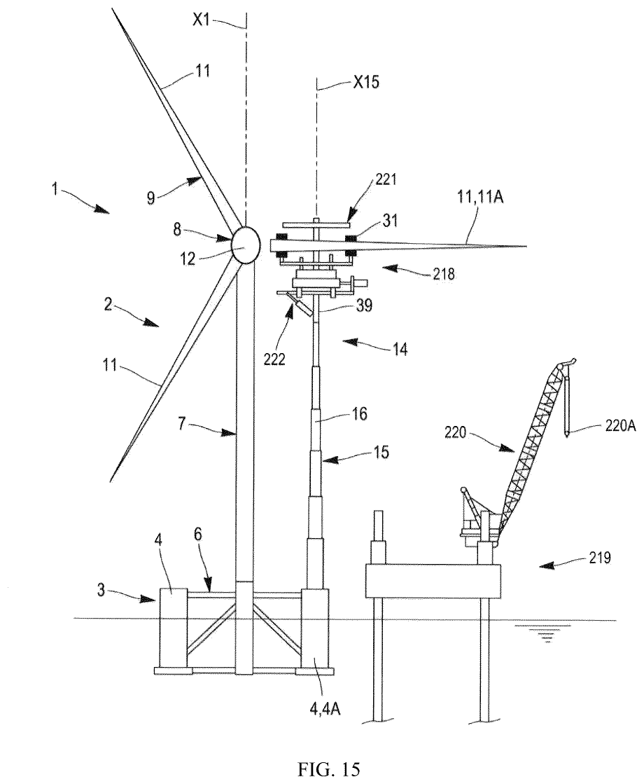

FIG. 15 is a diagrammatic elevation overview of a change of blade of a wind turbine according to a method using a tool according to the invention;

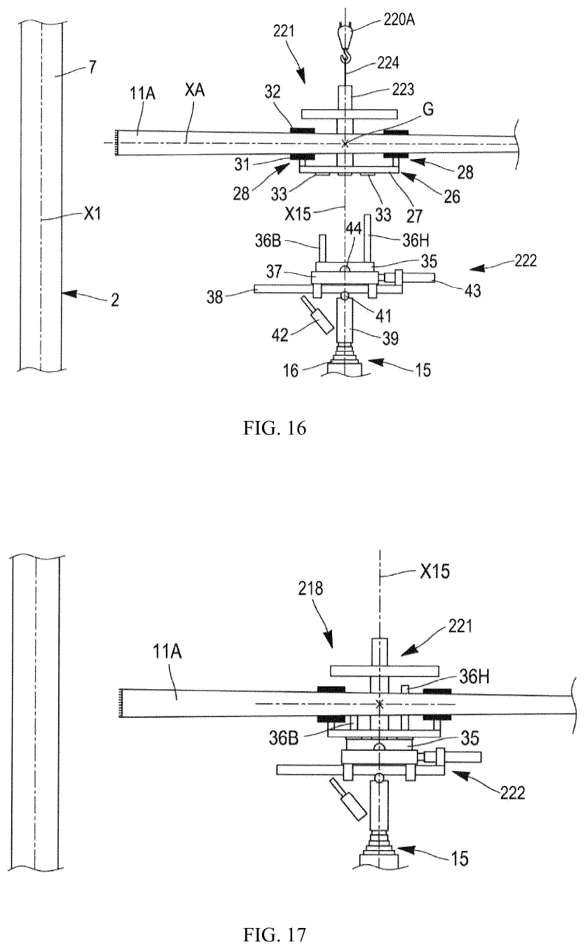

FIG. 16 is a diagrammatic elevation view of a first step of this method, wherein a blade to be installed on the wind turbine is supplied;

FIG. 17 is a diagrammatic elevation view of a second step of the method wherein the blade is arranged on a hoisting system;

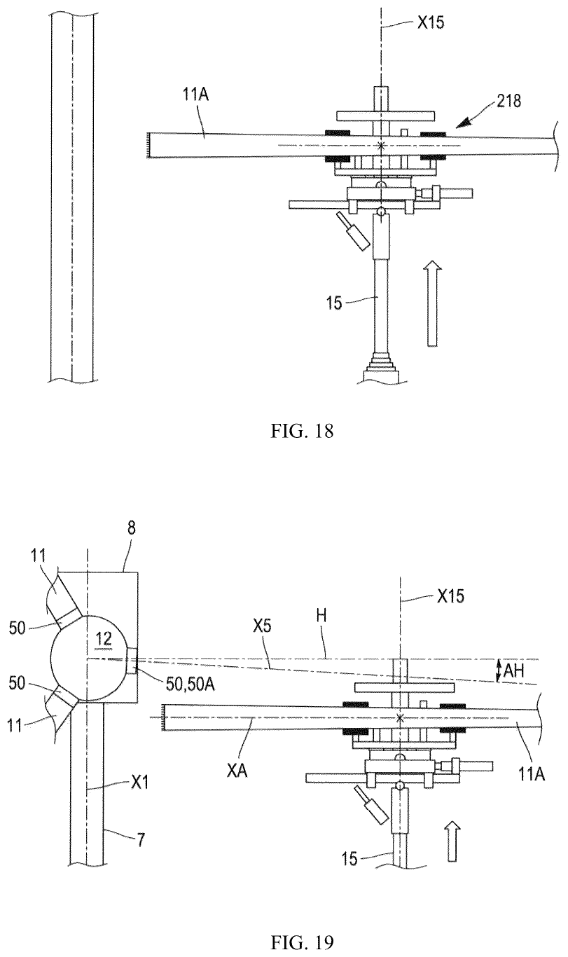

FIG. 18 is a diagrammatic elevation view of a third step of the method, wherein the hoisting system raises the blade;

FIG. 19 is a diagrammatic elevation view of a fourth step of the method, wherein the hoisting system moves the blade towards the rotor of the wind turbine;

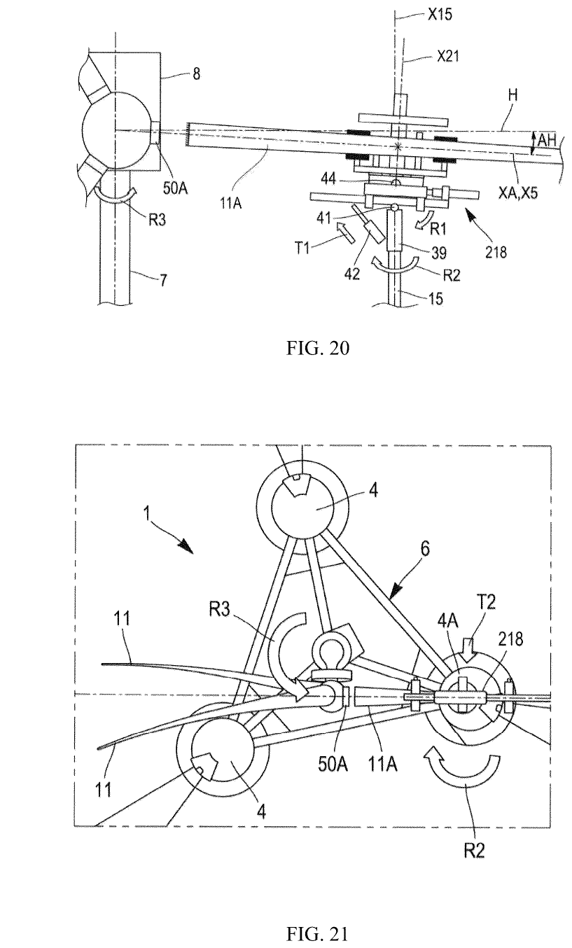

FIG. 20 is a diagrammatic elevation view of a fifth step of the method, wherein the tool orients the blade towards a flange to which it must be attached;

FIG. 21 is a diagrammatic plan view of the fifth step;

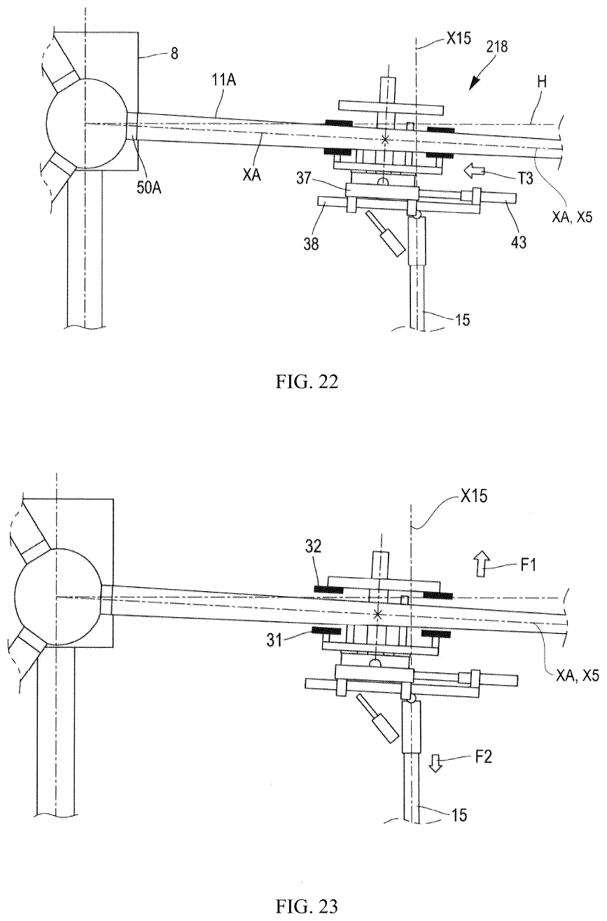

FIG. 22 is a diagrammatic elevation view of a sixth step of the method, wherein the tool brings the blade into contact with the flange to attach it thereon;

FIG. 23 is a diagrammatic elevation view of an eighth step of the method, wherein the tool releases the blade; and,

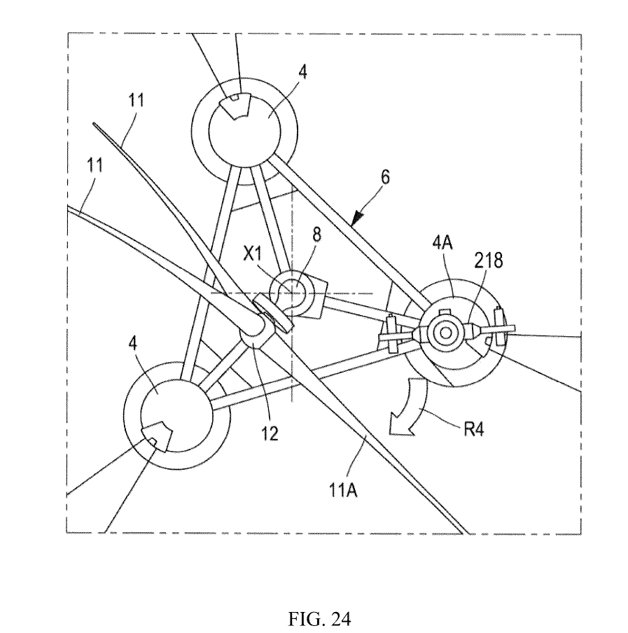

FIG. 24 is a diagrammatic plan view of an eighth step of the method, wherein the nacelle of the wind turbine rotates to release the blade from the tool.

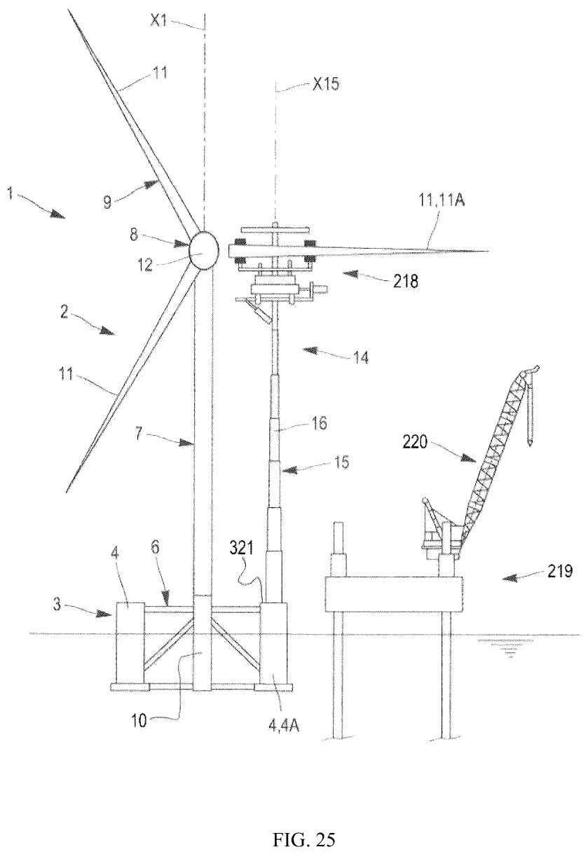

FIG. 25 is a diagrammatic elevation overview of a first method for maintaining a wind turbine wherein a tool attached to the top of a telescopic tower supported by a floater of a platform supporting the wind turbine is used;

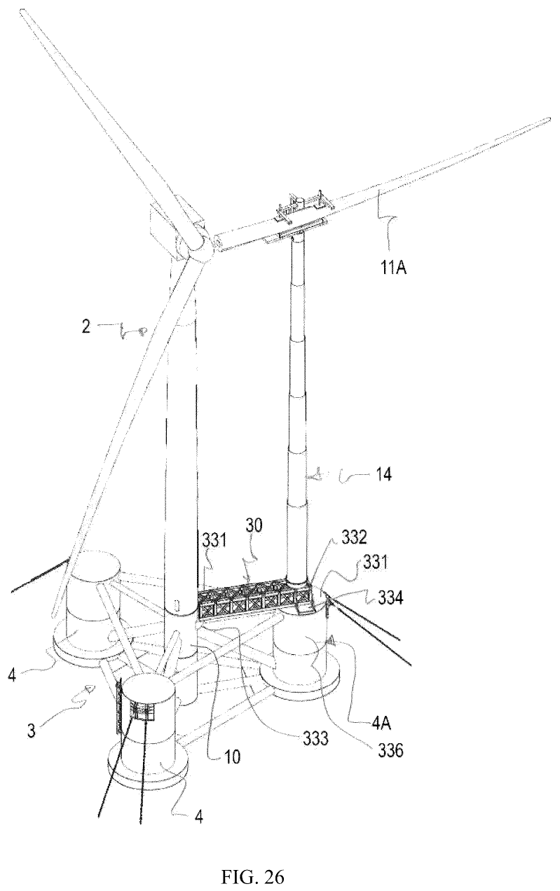

FIG. 26 is a diagrammatic perspective overview of a second method for maintaining a wind turbine which differs from that shown on FIG. 25 in that, in this case, the telescopic tower is supported by a framework arranged between a floater and the mast of the wind turbine;

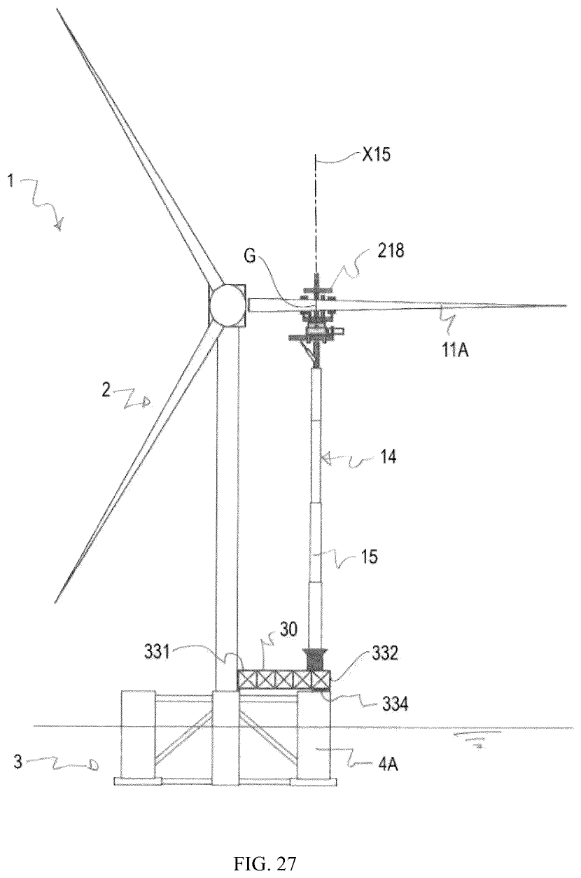

FIG. 27 is a diagrammatic elevation overview of changing a blade of the wind turbine using the method shown on FIG. 26;

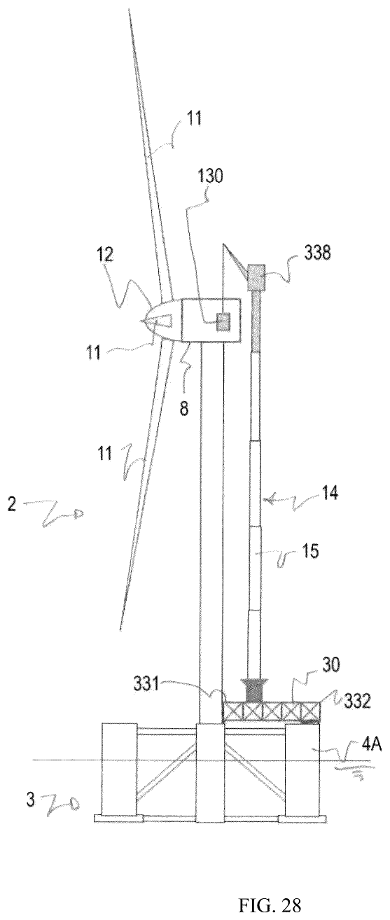

FIG. 28 is a diagrammatic elevation overview of handling a heavy load using the method shown on FIG. 26;

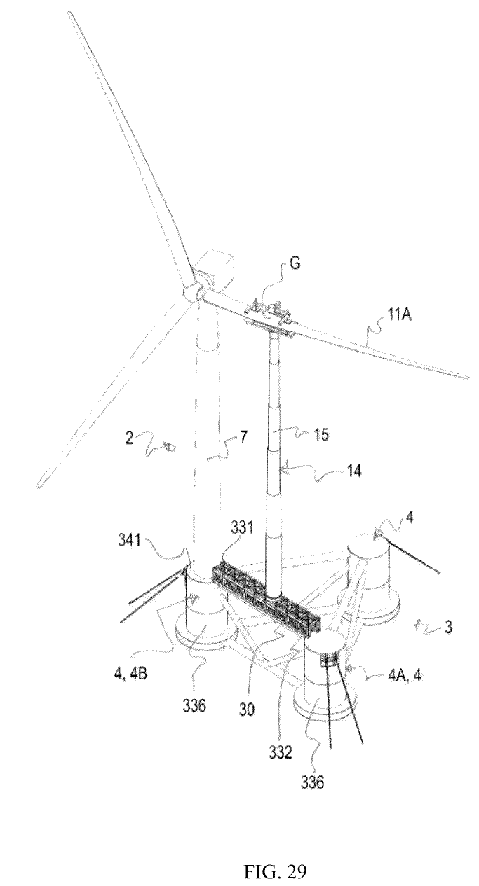

FIG. 29 is a diagrammatic perspective overview of a third method for maintaining a wind turbine which differs from those shown on FIGS. 25 and 26 in that, in this case, the telescopic tower is supported by a framework arranged between two floaters, one of which supports the mast of the wind turbine;

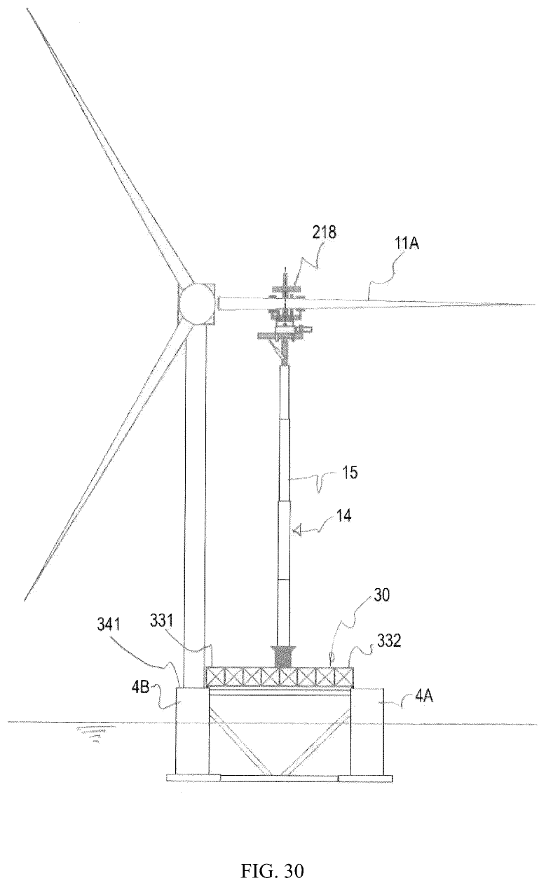

FIG. 30 is a diagrammatic elevation overview of changing a blade of the wind turbine using the method shown on FIG. 29;

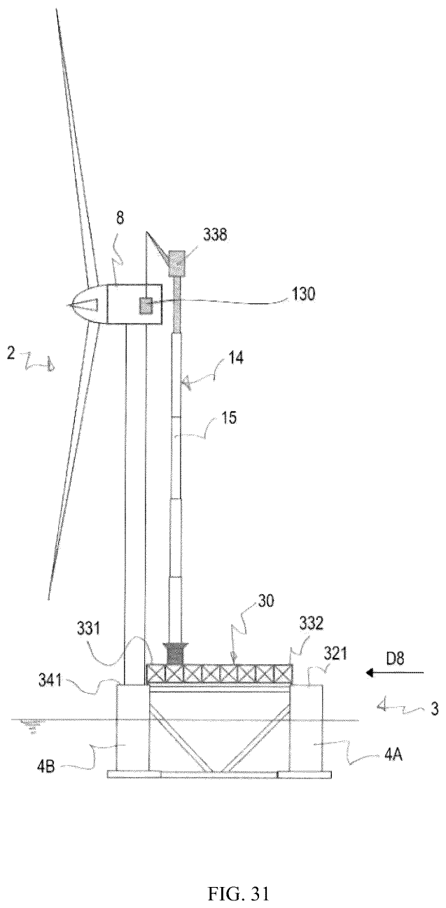

FIG. 31 is a diagrammatic elevation overview of handling a heavy load using the method shown on FIG. 29;

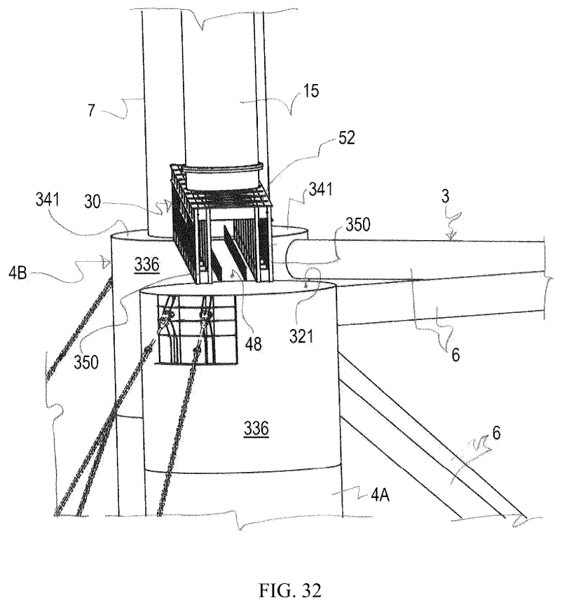

FIG. 32 is a diagrammatic perspective view of the details of a support framework used in the method shown on FIG. 29;

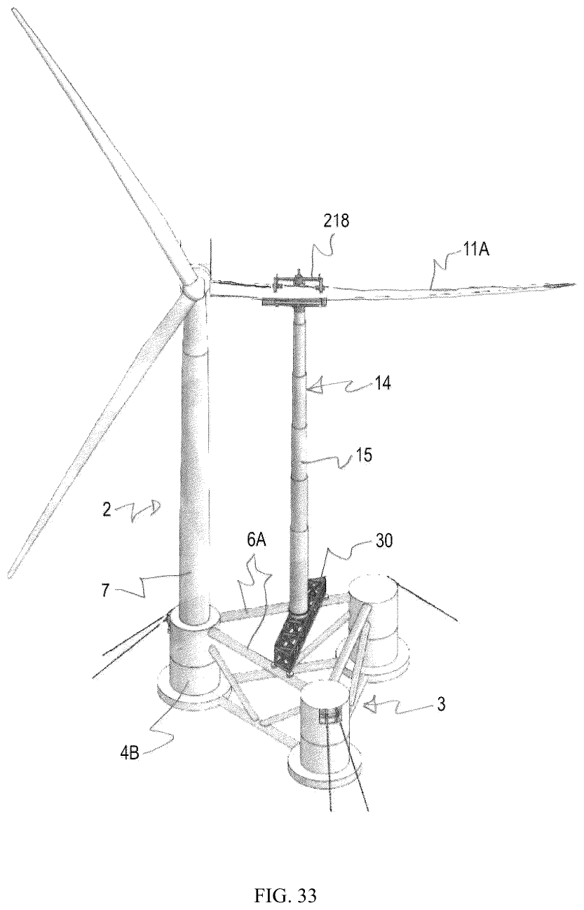

FIG. 33 is a diagrammatic perspective overview of a fourth method for maintaining a wind turbine which differs from those shown on FIGS. 26 to 32 in that the telescopic tower is supported by a framework whose ends rest on tubular beams connecting the floaters together; and,

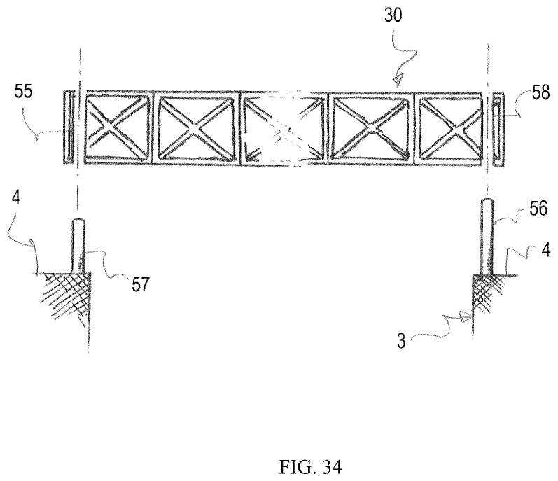

FIG. 34 is a diagrammatic view of an embodiment of a framework according to the invention.

### DETAILED DESCRIPTION

We will now describe the first object of the invention, in reference to FIG. 14. In the description, the terms “vertical” and “horizontal” refer to an equilibrium position of the wind turbine system, as shown on the figures, arbitrarily assuming that there is no wind or swell. The mast of the wind turbine is considered to be vertical to simplify the description, although in actual fact its position is subject to the effects of the swell and the wind. In addition, the terms “left” or “right” are not absolute and generally refer to a position on one of the figures, and should in no way be construed as a limitation to the scope of the invention.

FIG. 14 shows a wind turbine system 1. In the example shown, the system comprises a wind turbine 2 mounted on a floating platform 3. The platform 3 comprises floaters 4 and a rigid structure 6. There are generally three or four floaters. The wind turbine extends vertically along a main axis X1 and the floaters are distributed evenly around this axis X1. The structure 6 connects the floaters together and supports the wind turbine 2. Such a system is described in particular in document FR 3 053 020 A1 (Dietswell).

In this example, the wind turbine comprises a tubular mast 7 supporting at its top a nacelle 8 having a unique rotor 9 with three blades 11 attached to a nose 12.

FIG. 14 shows the change of a blade 11A implementing a method according to the invention using a crane 14. The crane 14 is mounted at the top of a support floater 4A selected from the floaters 4 of the platform 3.

In the example shown, the crane comprises a mast 16 and a hoisting head 17. The mast 16 extends vertically along a crane axis X14 parallel to the main axis X1, from the support floater 4A. The mast comprises a lower element 16A, two intermediate elements 16B and an upper element 16C. The intermediate elements 16B are substantially identical to each other. The hoisting head 17 is attached to the upper element 16C.

The support floater 4A comprises attachment means (not shown) for a base of the mast 16. The lower element 16A comprises or forms the base of the mast 16.

The head comprises a sleeve 18 and a double jib 20. The sleeve 18 is attached to the upper element 16C; it is shifted relative to the mast 16 of the crane 14. On FIG. 14, the sleeve is shifted towards the front of the figure. The double jib 20 is mounted in the sleeve so as to slide horizontally therein. On FIG. 14, sliding occurs from the left to the right of the figure. The double jib 20 comprises two ends 20D, 20G, projecting from the sleeve, respectively on the right and left of the sleeve on FIG. 14. The sleeve is shifted relative to the mast so that the blade 11A being handled does not collide with the mast.

Each end 20D, 20G of the jib 20 has a respective hoist rope 21, mounted on winch. Each rope 21 has a hook 22.

The jib 20 can slide horizontally in the sleeve 18 to move the blade towards or away from the nose. Simultaneous winding or unwinding of the ropes 21, at the same speed, allows the blade to translate, respectively upwards or downwards. The ropes can be used independently to control the inclination of the blade relative to the horizontal.

In the position shown, the blade 11A to be changed rests horizontally on the hooks 22, opposite the nose 12. In this position, the blade 11A can be bolted to or unbolted from the nose 12.

Advantageously, at least the intermediate and upper elements 16B-16C of the mast 16 can be telescoped relative to each other. Thus, the crane can be mounted using a floating crane of reduced capacity and radius.

The elements can be tubular or have a lattice structure.

In a method according to the invention, the nacelle is first oriented and kept in a position which does not obstruct the mounting of the crane, then the crane is mounted. When the blade 11A has to be removed, a mechanism can be used to change the yaw of the nacelle about the main axis X1 to bring the blade towards the crane and place it in a position in which it can be easily grasped by the hoisting means. When a new blade has been installed, the same mechanism can be used to move the blade away before dismantling the crane.

Obviously, this first object of the invention is not limited to the examples which have just been described. On the contrary, the invention is defined by the following claims.

It will appear to those skilled in the art that various modifications can be made to the embodiments described above, in reference to FIG. 14, in the light of the information that has just been disclosed.

Thus, small braces can be installed between the mast of the wind turbine and the crane mast so that a lighter crane can be used.

Also, instead of independent ropes, the hoisting head may comprise a spreader bar. Also, instead of hooks, the hoisting means may comprise at least one cradle on which the blade can rest, while it is being implemented; thus, by simply moving this cradle vertically, the blade to be handled can be picked up or released.

Such a method is not reserved to wind turbines of the type described, in particular not to the wind turbines mounted on a structure connecting floaters and described in document FR 3 053 020 A1 (Dietswell). Such a method can also be applied when the wind turbine is not centred on the structure, but offset; for example, supported by one of the floaters, as described in document EP 2 727 813 A1 (Principle Power INC) or for example on the edge of a concrete ring, as described in document FR 2 970 696 A1 (Ideol). Such a method can also be applied to wind turbines mounted on a platform such as a barge or to wind turbines whose platform comprises rigid anchors keeping it attached to the seabed.

Since the crane is attached to the platform of the wind turbine, they have relatively fixed positions, despite the movements due to the swell and the wind, thereby considerably reducing the difficulties of installing the blade. In addition, the use of a modular crane reduces the means required to install the blade. In addition, there is no need to take the platform and its wind turbine to a port, which means in particular that the production shutdown caused by changing the blade is much shorter.

Obviously, a crane according to the invention can be used for activities other than changing a blade. For example, it can be used for heavy maintenance activities, such as changing equipment located in the nacelle, in particular changing a generator or a transformer.

We will now describe the second object of the invention, in reference to FIGS. 1 to 13. Some of the terms used, such as “left” or “right”, are not absolute and generally refer to a position on one of the figures, and should in no way be construed as a limitation to the scope of the invention.

FIGS. 1 to 13 show a wind turbine 2. In the example shown, the wind turbine 2 comprises a tubular mast 7 supporting at its top a nacelle 8 having a unique rotor 9 with three blades 11 attached to a nose 12. The wind turbine is an offshore fixed wind turbine 208. The mast 7 extends along a vertical wind turbine axis X1 from the seabed 109, in which it is anchored.

FIGS. 1 to 6 show the change of a blade 11A implementing a first method according to the invention using a hoisting system 111. FIGS. 1 to 6 show a first embodiment of the hoisting system. The system 111 is mounted on a jack-up self-elevating platform 112. The platform 112 comprises a secondary luffing jib crane 113, having a metal lattice structure.

As shown on FIG. 1, the platform 112 is floated to the wind turbine 2. It supports, lying on its deck 112P, a blade 11B to replace the damaged blade 11A.

FIGS. 2 to 6 show the platform 112 immobilised near the mast 7 of the wind turbine 2, erected on its legs 112A which rest on the seabed 9. The platform 112 and the hoisting system 111 are arranged such that the axes X1 of the wind turbine and X111 of the system are at a first distance D1 from each other, adapted to implement the first method.

As shown on FIGS. 1 and 2, when moving the platform and when erecting it near the wind turbine, the hoisting system is in a retracted position P1. To reach the damaged blade 11A, the system can adopt a deployed position P2, as shown in particular on FIGS. 3 and 4.

In the example shown, the system comprises a mast 16 and a hoisting tool 117. The mast 16 extends vertically along a main axis X111 of the system parallel to the wind turbine axis X1, from the platform 112. The mast 16 comprises a lower element 16A, intermediate elements 16B and an upper element 16C. The tool 117 is attached to the upper element 16C. The lower element 16A comprises or forms a base of the mast 16. The platform 112 comprises attachment means (not shown) for the base of the mast 16. In this first embodiment, the intermediate elements 16B are mounted so that they can be telescoped relative to each other and inside the lower element 16A; they are telescoped in order to raise the mast from the retracted position P1 to the deployed position P2 and, vice versa, to lower the mast from the deployed position to the retracted position.

As shown in particular on detail D4 of FIG. 4, the tool 117 comprises a slide 118 and a double jib 120. The double jib is attached to the upper element of the hoisting system 111. The slide is mounted so as to slide horizontally on the double jib 120. The slide comprises at each of its ends a seat 119A, respectively on the right and on the left in the position of the figures. The seats 119A are designed so that a blade can be placed substantially horizontally on them, such that its centre of gravity is between the two seats. The slide 119 also comprises clamping means 119B, arranged above the seat 119A located on the right. The clamping means 119B are used to secure the blade on the seating means by clamping the blade between the clamping means and the seat located underneath.

We will now describe a method for replacing the damaged blade 11A by the spare blade 111B, in reference to FIGS. 1 to 6.

In a first step, shown on FIG. 1, the platform 112 is taken to the wind turbine 2, with the replacement blade 11B lying on its deck.

In a second step, shown on FIG. 2, when the hoisting system is sufficiently close to the wind turbine, the platform 112 is immobilised and erected on the seabed. The damaged blade is immobilised horizontally, above the platform 112, and the nacelle 8 is immobilised so that it cannot rotate about the wind turbine axis X1. In this position of the platform and of the damaged blade 11A, the axis X111 of the system is arranged near the centre of gravity 11G of the damaged blade, and the tool 117 is substantially vertically above the damaged blade.

In a third step, shown on FIG. 3, the mast of the hoisting system 111 is deployed until it reaches the deployed position P2. The slide 119 is shifted in the direction C1 (see FIG. 3) to the left relative to the axis X111 of the system. In this position, the tool 117 comes into contact with the damaged blade and holds it, so that it can be separated from the rotor 9. The centre of gravity 11G of the blade 11A is substantially centred on the slide 119. The orientation of the T and the height of the supports 119A are adjusted to ensure that the next step of separation takes place without damaging either the blade 11A, or the rotor 9.

In a fourth step, shown on FIG. 4, the damaged blade 11A is separated from the rotor 9; the slide, supporting the blade 11A, is shifted horizontally to the right in the direction C2 (see FIG. 4), so that the centre of gravity 11G of the damaged blade 11A substantially coincides with the axis X111 of the system.

In a fifth step, shown on FIG. 5, the mast 16 of the hoisting system 111 is retracted to its retracted position P1, wherein the damaged blade can be grasped by the secondary crane 113, using a hook device 113C.

In a sixth step, shown on FIG. 6, the secondary crane removes the damaged blade 11A from the tool 117 and places it on the deck 112P of the platform 112, beside the replacement blade 111B.

In the next steps, not shown but similar to the previous steps in the reverse order, the replacement blade 11B is attached to the rotor 9:
the secondary crane 113 grasps the replacement blade 11B and places it on the tool 117; then,
the mast 16 of the system 111 is deployed to the deployed position P2, wherein the replacement blade is opposite the rotor 9; then,
the slide is moved towards the rotor 9, the orientation of the T and the height of the supports 119A are adjusted until the replacement blade 11B is in a position such that it can be attached to the rotor 9; then,
the mast 16 is returned to its retracted position; then,
the platform 112 is separated from the seabed 109, then the platform moves away by floating, taking with it the damaged blade 11A.

We will now describe a second method implemented using the system according to the invention in reference to FIGS. 7 to 9. We will describe it indicating the differences compared with the first method described previously and indicating the differences for its implementation compared with the means used for the implementation of the first method.

This second method is used to hoist a heavy load 130; this load is housed in the nacelle 8 and must be removed from it. For the implementation of this second method, the tool 117 is equipped with winch means 117T, at least at one of its ends; on FIG. 7, the right-hand end of the tool is equipped with the winch means 117T. The tool 117 is mounted so as to rotate relative to the mast 16, about the axis X11 of the system.

In a first step, shown on FIG. 7, the platform 112 and the hoisting system 111 are arranged such that the axes X1 of the wind turbine and X111 of the system are at a second distance D2 from each other, adapted to implement the second method. The mast 16 is in a second deployed position P3. In this position, the mast reaches a size that is greater than that reached in the deployed position P2 shown in particular on FIGS. 3 and 4; the right-hand end of the tool is located above the nacelle 8; the winch means 117T comprise a rope 121 which extends vertically from this end to the load, to which it is attached.

In a second step, shown on FIG. 8, the load 130 is first extracted from the nacelle 8 vertically, upwards.

In a third step, shown on FIG. 9, the tool is then rotated about the axis X111 of the device, in this case through one hundred and eighty degrees, to move it away from the horizontal footprint of the wind turbine 2.

In next steps, not shown, the load 130 is then lowered onto the deck of the platform 112, to be evacuated.

Steps, not shown, similar to the previous ones but in the reverse order, are used to place a heavy load, taken by floating using the platform, in the nacelle.

Obviously, a similar method can be implemented using the same system or a similar system, to move any load or any equipment of the wind turbine.

We will now describe a third method implemented using a second embodiment of a system according to the invention, in reference to FIG. 10, using a second embodiment for the tool 117.

In this second embodiment, the tool 117 comprises a sleeve 118 and a double jib 120. The sleeve 118 is attached to the upper element 16C; it is shifted relative to the mast 16 of the system 111. On FIGS. 10 and 11, the sleeve is shifted towards the front of each figure. The double jib 120 is mounted in the sleeve so as to slide horizontally therein. On the figures, sliding occurs from the left to the right, and vice versa, of each figure. The double jib 120 comprises two ends 120D, 120G, projecting from the sleeve, respectively on the right and left of the sleeve on the figures. The sleeve is shifted relative to the mast so that the blade 11A being handled does not collide with the mast 16. Each end 120D, 120G of the jib 120 has a respective hoist rope 121, mounted on winch. Each rope 121 has a hook 122.

The system comprises a mast 16 and a tool 117. The mast 16 extends vertically along a system axis X111 parallel to the wind turbine axis X1, from the platform 112. The mast 16 comprises a lower element 16A, intermediate elements 16B and an upper element 16C. The hoisting head 117 is attached to the upper element 16C. The platform 112 comprises attachment means (not shown) for a base of the mast 16. The lower element 16A comprises or forms the base of the mast 16.

The jib 120 can slide horizontally in the sleeve 118 to move the blade 11A towards or away from the nose 12. Simultaneous winding or unwinding of the ropes 121, at the same speed, allows the blade 11A to translate, respectively upwards or downwards. The ropes can be used independently to control the inclination of the blade 11A relative to the horizontal.

In the position shown on FIG. 10, the blade 11A to be changed rests horizontally on the hooks 122, opposite the nose 12. In this position, the blade 11A can be bolted to or unbolted from the nose 12.

The system 111 can be mounted using the secondary crane 113 or a floating crane of reduced capacity and radius, compared with what is required to handle the blade 11A.

Advantageously, as in the embodiments shown on FIGS. 1 to 9, at least some of the intermediate and upper elements 16B-16C of the mast 16 can be telescoped relative to each other; thus, a system of even lower capacity can be used to mount the system 111.

The elements 16A-16C can be tubular or have a lattice structure.

On FIG. 11, the blade 11A to be changed is detached from the nose 12 and suspended from the ropes 121. It is shown as it is being lowered. The system 111 is advantageously arranged on the platform 112 in order to place the blade 11A on an annex boat coupled to the platform 112 or on the platform 112 itself. In this last case, the secondary crane 113 can be designed to pick up the blade 11A on the platform 112 and place it on the annex boat or on a quayside, if the platform was used to bring the blade 11A thereto.

In a reverse process, a new blade can be installed to replace the blade 11A removed from the wind turbine 1.

Referring to FIG. 12, we will now describe an improvement of the embodiment and of the method described on FIGS. 7 to 9, mentioning only the differences.

In this case, the system shown comprises a horizontal arm 131 rigidly connecting the upper element 16C to the nacelle 8. This arm secures the mast 16. It can be used to optimise the system, in particular to use a mast of lighter cross-section, which is easier to move and implement.

Instead of a single fixed arm connected to the nacelle, at least one of the intermediate elements 16B may comprise an arm mounted so as to slide on the post, for example on a rail provided for this purpose, such that the rigidity of the mast 7 of the wind turbine ensures the rigidity of the mast 16 of the system 111 when deploying or retracting the mast. This allows the use of a lighter system, as well as a lighter secondary crane, to install the system.

Referring to FIG. 13, we will now describe a third embodiment, indicating the differences compared with the embodiments described previously.

In this embodiment, the system comprises a fixed base 135 on the deck 112P of the platform 112. The mast 16, in particular the lower element 16A, is mounted so as to rotate on the base 135. The hoisting tool 117 comprises a horizontal beam 136 rigidly arranged at the top of the upper element 16C, of which each branch extends on each side of the axis X111 of the system over the same distance L136. A winch 137 is attached to the lower element 16A, such that it rotates about the axis X111 of the system, at the same time as the mast 16. A rope 138, connected to the winch, is used to hoist a load 130. The system comprises a first rope return 139A and a second rope return 139B, for example pulleys, each arranged at a respective end of the beam 136 such that:
the rope is substantially horizontal between the two returns;
the rope extends vertically between the winch and the first return 139A; and,
a free end of the rope extends past the second return 139B to suspend the load 130.

With this arrangement, the hoisting loads are substantially aligned with the axis X111 of the system 111, such that the system is optimised.

Obviously, this second object of the invention is not limited to the examples which have just been described. On the contrary, the invention is defined by the following claims.

It will appear to those skilled in the art that various modifications can be made to the embodiments described above, in reference to FIGS. 1 to 13, in the light of the information that has just been disclosed.

Thus, the jack-up platform does not have to be equipped with a secondary crane. In this case, a return to port can be made with the system in the retracted position and the blade placed on the hoisting tool, then, the blade can be replaced by a port crane or another hoisting means and the platform can then return to the wind turbine to install the new blade.

The system may consist of a tower crane equipped with a jib rotating about a vertical axis.

Thus, in the second embodiment, the tool may comprise a spreader bar instead of independent ropes.

In the methods according to the present invention, since the system and the wind turbine are attached to the seabed, at least indirectly, they have relative fixed positions; this significantly reduces the difficulties when handling a blade. In addition, the use of a modular system reduces the means required to handle the blade. A more ordinary type of jack-up platform can therefore be used, that is more available and less expensive.

The methods according to the present invention are not reserved to wind turbines of the type described. These methods can also be applied to wind turbines mounted on a platform such as a barge or to wind turbines whose platform comprises rigid posts keeping it attached to the seabed or wind turbines mounted on gravity-based foundations.

Also, a method according to the invention can be used to repair a blade, the same blade being put back into position after the maintenance operation. This maintenance is advantageously carried out on the platform 112, if the blade does not have to be taken back to a port.

We will now describe the third object of the invention, in reference to FIGS. 15 to 24. In the following description, some of the terms used, such as “left” or “right”, are not absolute and generally refer to a position on one of the figures, and should in no way be construed as a limitation to the scope of the invention. The mast of the wind turbine is considered to be vertical to simplify the description, although in actual fact its position is subject to the effects of the swell and the wind.

FIG. 15 shows a wind turbine system 1. In the example shown, the system comprises a wind turbine 2 mounted on a floating platform 3. The platform 3 comprises floaters 4 and a rigid structure 6. There are generally three or four floaters. The wind turbine extends vertically along a main axis X1 of the wind turbine and the floaters are distributed evenly around this axis X1. The structure 6 connects the floaters together and supports the wind turbine 2. Such a floating wind turbine system is described in particular in document FR 3 053 020 A1 (Dietswell).

In the example shown, the wind turbine 2 comprises a tubular mast 7 supporting at its top a nacelle 8 having a unique rotor 12 with three blades 11 attached to the rotor 12. The mast 7 extends along the wind turbine axis X1.

FIG. 15 shows the change of a blade 11A implementing a method according to the invention using a hoisting device 14 comprising a tower 15. The device 14 is mounted at the top of a support floater 4A selected from the floaters 4 of the platform 3. The tower 15 is vertical about a hoisting axis X15; in the example shown, it comprises six tubular elements 16 mounted so as to slide vertically in each other. The device 14 is equipped, at the top of the tower, with a tool 218 for gripping a blade 11A selected from the blades 11.

The hoisting device 14 and the tool 218 are defined so that the load distribution of the tool 218 and the blade 11A it supports always remains as close as possible to the neutral fibre, in other words to the axis X15 of the tower 15, to substantially avoid any moment, any radial stress or even buckling.

A barge 219 is waiting near the wind turbine system 1. It is equipped with a luffing jib crane 220 having a lattice structure. The barge 219 is used to bring the blade 11A if it is new or take it away if it is damaged; it is used to exchange the damaged and replacement blades. In the example shown, a jack-up barge 219 is used; if the seabed is too deep, a barge kept floating near the system 1 can be used. Using means and the method according to the invention, the relative movements of the wind turbine system 1 and of the barge 219 do not represent a problem to handle the blade 11A. This operation can be carried out without damaging the blade or the wind turbine.

FIGS. 16 to 24 show the installation of a new blade 11A on the wind turbine 2, using the tool 218.

We will now describe the tool 218, in reference to FIG. 16. As shown in particular on FIG. 16, the tool 218 comprises two main parts 221, 222, that can be separated from each other; a first part forms a spreader bar 221 to grip the blade 11A, the second part is a positioner 222 to position the plate relative to the rotor 12. On the figures, the positioner 222 is attached at the top of the tower 15. On FIG. 16, the tower is in the retracted position, in other words the elements 16 are inserted into each other.

In particular to describe FIG. 16, longitudinal refers to what is substantially parallel to the blade, in other words what extends from left to right on the figure; transverse refers to what is perpendicular to the plane of the figure, therefore transverse to the blade, in a horizontal plane.

The spreader bar 221 comprises:
an upright 223 rising in a transverse vertical plane,
a sling 224 attached to an upper end of the upright; and,
gripping means 26, attached to a lower end of the upright.

In the example shown, the gripping means 26 comprise a yard 27 arranged longitudinally and two clamps 28, each at a respective longitudinal end of the yard 27. In addition, the yard supports two sleeves 33.

Each part 28 comprises a lower jaw 31 and an upper jaw 32. The lower jaw is fixed relative to the yard 27 and to the upright 223. The upper jaw can move vertically, such that when the blade rests on the lower jaw, the upper jaw clamps it to hold it.

The positioner 222 comprises a base 35 on which the spreader bar 221 can be placed. Two poles 36B, 36H extend vertically upwards from the base 35. The poles are designed so that each one can be tightly inserted in a respective sleeve 33 of the spreader bar 221. The poles have different heights, so that the taller pole 36H is first inserted in its respective sleeve then the shorter pole 36B is inserted in its sleeve. Thus, since the poles are not inserted at the same time, the operation is easier. The base 35 and the poles 36A, 36B are used to precisely couple the spreader bar 221 and the positioner 222.

The positioner 222 further comprises a trolley 37, a longitudinal guide, in this case a longitudinal beam 38, and a connector 39. In the example shown, the connector has the shape of a column which is attached to an upper end of the tower 15. The connector is equipped with means to allow rotation about the vertical axis X15.

The beam 38 is arranged at an upper end of the connector; it is connected to the latter by a hinge allowing it to tilt about a transverse horizontal axis. A tilt actuator 42 is used to control the tilting; in the example shown, the tilt actuator 42 is a cylinder mounted functionally between the connector and the beam.

The trolley 37 is mounted so as to slide longitudinally on the beam 38. A longitudinal actuator 43 is used to control a longitudinal translation of the trolley relative to the beam; in the example shown, this actuator is a longitudinal cylinder 43, mounted functionally between the trolley and the beam.

The base 35 is mounted so as to slide transversally on the trolley 37. A transverse actuator 43 is used to control a transverse translation of the base 35 relative to the trolley; in the example shown, this actuator is a longitudinal cylinder 44, mounted functionally between the trolley and the base. Since this cylinder is transverse, it is shown on the figures by a circle.

FIG. 16 shows a first step to position the blade 11A on the wind turbine 2. In previous steps, the blade 11A was positioned in the spreader bar 221 and the spreader bar was used to load the blade on the barge 219.

In this first step, the spreader bar 221 is suspended by its sling 224 to a hook 220A of the crane 220 of the barge 219, above the positioner 222. In the position shown, the poles 36B, 36H are substantially aligned with the sleeves 33. Note that the spreader bar 221 is designed so that the blade 11A can be arranged thereon such that, in the position of FIG. 15, its centre of gravity G is substantially aligned with the axis X15 of the tower 15; the blade has a substantially horizontal longitudinal axis XA, passing through the centre of gravity G.

FIG. 17 shows a third step to position the blade 11A on the wind turbine 2. In this step, the spreader bar has been inserted into the positioner 222. For this insertion, as the spreader bar was moved towards the positioner, the tall pole 36H was first inserted in the corresponding sleeve 33, then the short pole 36B was inserted in the other sleeve 33. In the position of FIG. 17, the tool 218 is formed; the spreader bar rests on the base 35 and is no longer held by the crane 220.

FIG. 18 shows a third step to position the blade 11A on the wind turbine 2. In this step, the tower 15 is being deployed upwards and the blade 11A is raised.

FIG. 19 shows a fourth step to position the blade 11A on the wind turbine 2. In this step, the tower 15 continued to be deployed and the blade 11A to be positioned is virtually at the same height as the rotor 12. The rotor comprises three flanges 50 to attach the blades thereto. Two of the flanges 50 are each occupied by their respective blade 11. The third flange 50A is free to receive the blade 11A to be installed thereto. The flange 50A has a flange axis X5 which must be aligned with the axis XA of the blade 11A in order to attach it to the flange 50A.

Note that, in the plane of the figure, the axis X5 of the flange is inclined at an angle AH relative to a horizontal plane H.

FIGS. 20 and 21 show a fifth step to position the blade 11A on the wind turbine 2. In this step, the axis XA of the blade is aligned with the axis X5 of the flange 50A to which it must be attached. To perform this alignment step, three degrees of freedom offered by the positioner 222 are used.

As shown on FIGS. 20 and 21:
an action of the cylinder 42 in the direction of the arrow T1 (see FIG. 20) can be used to tilt the blade 11A about the pivot 41;
an action of the connector 39 allows a rotation in the direction of the arrow R2 of the blade about the axis X15 of the tower;
an action of the cylinder 44 in the direction of the arrow T2 (see FIG. 21) allows a transverse translation of the blade 11A.

In addition, a rotation in the direction of the arrow R3 of the nacelle 8 about the axis X1 of the wind turbine is used which, combined with the rotation R2 and the translation T2 of the blade 11A, can be used to align in the horizontal plane the blade 11A to be positioned and the flange; this is shown in particular on FIG. 21.

The alignment can be carried out by an operator using remote control means. It can also be carried out automatically, for example using laser beams and targets.

FIG. 22 shows a seventh step to position the blade 11A on the wind turbine 2. In this step, the blade 11A to be positioned is attached to its flange 50A. Since their axes XA and X5 are aligned, the blade 11A is moved forward until it is in contact with the flange 50A. To do this, the trolley 37 is moved in translation along the beam 38, in the direction of the arrow T3, using the longitudinal cylinder 43. Once in contact, the blade 11A is attached to its flange 50A, for example by bolting.

FIG. 23 shows an eighth step to position the blade 11A on the wind turbine 2. In this step, the upper jaws 32 are raised, in the direction of the arrow F1, then the tool is lowered in the direction of the arrow F2 by retracting the tower 15, so that the blade 11A placed in position is not in contact with the jaws 31, 32.

FIG. 24 shows a ninth step to position the blade 11A on the wind turbine 2. In this step, the nacelle is rotated in the direction of the arrow R4 in order to move the blade out of the vertical footprint of the tool 218.

In subsequent phases, the tool is realigned on the axis X15 of the tower 15, then the tower is retracted.

Obviously, this third object of the invention is not limited to the examples which have just been described. On the contrary, the invention is defined by the following claims.

It will appear to those skilled in the art that various modifications can be made to the embodiments described above, in reference to FIGS. 15 to 24, in the light of the information that has just been disclosed.

Thus, steps similar to those described previously, substantially in the reverse order, can be used to remove a damaged blade, before installing a new replacement blade.

Also, the poles can be carried by the spreader bar and be inserted in sleeves of the positioner. They can also be shorter than as shown on the figures.

Also, the beam of the positioner can, for example, be replaced by two parallel beams or by a plate, for greater stability.

The means for rotating about the tower axis can be specific to the tower and not to the tool connector.

The sling of the spreader bar can be replaced by any hooking means, in particular a ring or a hook.

We will now describe the fourth object of the invention, in reference to FIGS. 25 to 34. In the following description, some of the terms used, such as “left” or “right”, are not absolute and generally refer to a position on one of the figures, and should in no way be construed as a limitation to the scope of the invention. Also, the mast of the wind turbine is considered to be vertical to simplify the description, although in actual fact its position is subject to the effects of the swell and the wind.

FIG. 25 shows a wind turbine system 1. In the example shown, the system comprises a wind turbine 2 mounted on a floating platform 3. The platform 3 comprises floaters 4 and a rigid structure 6. There are generally three or four floaters. The wind turbine extends vertically along a main axis X1 of the wind turbine and the floaters are distributed evenly around this axis X1. The structure 6 comprises tubular beams connecting the floaters together; it supports the wind turbine 2. Such a floating wind turbine system is described in particular in document FR 3 053 020 A1 (Dietswell).

In this example, the wind turbine comprises a tubular mast 7 resting on the structure 6 and extending vertically upwards, along the main axis X1. It supports at its top a nacelle 8 having a unique rotor 9 with three blades 11 attached to a nose cone 12. The mast comprises a tubular leg 10 which extends substantially over the same height as the floaters 4. The structure 6 comprises in particular tubular beams 6A which connect the floaters 4 together and connect the leg 7A of the mast to the floaters.

FIG. 25 shows the change of a blade 11A implementing a method according to the invention using a hoisting device 14 comprising a tower 15. The device 14 is mounted at the top of a support floater 4A selected from the floaters 4 of the platform 3. The tower 15 is vertical about a hoisting axis X15; in the example shown, it comprises six tubular elements 16 mounted so as to slide vertically in each other. The device 14 is equipped, at the top of the tower, with a gripping tool 218 for gripping the blade 11A which is being changed.

A barge 219 is waiting near the wind turbine system 1. It is equipped with a luffing jib crane 220 having a lattice structure. The barge 219 is used to bring the blade 11A if it is new or take it away if it is damaged; it is used to exchange the damaged and replacement blades. In the example shown, a jack-up barge 219 is used; if the seabed is too deep, a barge kept floating near the system 1 can be used.

However, this method places considerable stress on the floor 321 which closes the floater at its upper end; the floor must therefore be reinforced, thereby making the floater considerably heavier. In case of a wind turbine farm, the floor of each wind turbine platform would have to be reinforced, to cater for the unlikely possibility of having to perform a heavy maintenance operation on one of them. The cost would be excessive.

In the examples which will be described below, in reference to FIGS. 25 to 34, a framework 30 acting as intermediate support for the hoisting device 14 is used. In these examples, the framework consists of a lattice beam.

In a second embodiment shown on FIGS. 25 to 28, the wind turbine 2, as in the example of FIG. 24, is centred relative to the floaters; in this case, there are three floaters, distributed evenly around the leg 10 of the mast of the wind turbine 2. A first end 331 of the framework 30 rests on the leg 10 of the mast 7 and a second end 332 of the framework rests on a floater 4A. The leg carries a bracket 333 which extends towards the support floater 4A, on which the first end 331 of the framework rests. The second end 332 comprises a transverse trimmer joist 334 which substantially transfers the loads onto the cylindrical peripheral wall 336 of the support floater 4A that is sufficiently rigid to withstand the weight without having to reinforce it significantly for this specific use.

The example of FIGS. 26 and 27, similar to that of FIG. 25, shows the handling of a blade 11A. The hoisting device 14 is arranged near the second end 332 of the framework 30, so that when the blade 11A is handled, its centre of gravity G is always as close as possible to the vertical line above the tower 15 of the device 14. Due to the presence of the trimmer joist, the tower 15 can be substantially arranged in the extension of the support floater 4A, without placing any stress on the floor 321.

The example of FIG. 28 shows the handling of a heavy load 130 to be installed in the nacelle 8 of the wind turbine 2. The top of the tower of the hoisting device 14 is equipped with a top crane 338, adapted to hoist the load 130, instead of the tool 218 used to handle the blade. The tower is arranged on the structure 30, closer to the first end 331 than the second end 332, so that the radius required to hoist the load is minimised; this limits the weight of the top crane and limits the bending moment exerted on the tower, thereby allowing the use of a lighter tower.

In a third embodiment shown on FIGS. 29 to 31, there are three floaters. Unlike the examples described previously, a base floater 4B, selected from the three floaters 4, acts as leg for the mast of the wind turbine 2. The floor closing the top of the base floater 4B forms an annular brim 341 around the mast. A first end 331 of the framework 30 rests on the brim 341 and a second end 332 of the framework rests on a support floater 4A. For each of the two ends 331, 332, the framework rests substantially on the cylindrical peripheral wall 336 of the floaters 4A, 4B that is sufficiently rigid to withstand the weight without having to reinforce it significantly for this specific use.

The example of FIGS. 29 and 30, similar to that of FIGS. 26 and 27, shows the handling of a blade 11A. The hoisting device 14 is arranged away from the two ends 331, 332 of the framework 30, so that when the blade 11A is handled, its centre of gravity G is always as close as possible to the vertical line above the tower 15 of the device 14.

The example of FIG. 31, similar to that of FIG. 28, shows the handling of a heavy load 130 to be installed in the nacelle 8 of the wind turbine 2. The top of the tower of the hoisting device 14 is equipped with the top crane 338. The tower is arranged on the structure 30, closer to the first end 331 than the second end 332, so that the radius required to hoist the load 130 is minimised.

FIG. 32 is an enlarged perspective view of the framework 30, substantially in the direction marked D8 on FIG. 31. FIG. 32 shows that the platform 3 comprises a pedestrian catwalk 48 connecting the floor 321 of the support floater 4A and the brim 341 of the base floater 4B so that the wind turbine operators can move from one floater to the other.

The framework 30 has a section having the shape of an inverted “U”, comprising two longitudinal girders 350, arranged one on each side of the catwalk 48; it further comprises a longitudinal apron 52, connecting the two longitudinal girders 350 together and covering the catwalk 48. With this arrangement, the structure 30 can be used without modifying the platform 3.

FIG. 33 shows a fourth embodiment of the invention. In this example, as in those of FIGS. 29 to 32, the wind turbine is attached to a base floater 4B. The top of the base floater is connected to the top of each of the two other floaters by a respective horizontal beam 6A of the structure 3. Each end of the framework 30 rests on a respective beam 6A; the framework forms with the beams a substantially equilateral triangle with the framework as its base, the wind turbine being placed at the vertex opposite the base. The tower 15 is attached substantially half-way between the ends of the framework.

In this case, the hoisting device 14 as shown on FIGS. 25, 26 and 27 is used to handle a blade 11A. To handle a heavy load, the beam can be moved closer to the mast 7 of the wind turbine, while keeping a similar configuration.

FIG. 34 shows means that can be used to position a framework 10 according to the invention on the structure 3 of a wind turbine system, for example on two neighbouring floaters 4. In the example shown, each floater supports a respective pole 56, 57, both being substantially vertical. A first pole 56 is taller than the second pole 57. Each pole is designed to be inserted in a respective housing 58 formed at a respective end of the framework 30.

When positioning the framework on the structure, the first pole enters its housing first, in order to position the corresponding end of the framework. Once this first end has been correctly positioned and held by the first pole 56, the second shorter pole must be inserted in its own housing 58, in order to position and hold the second end of the framework. Such an arrangement allows the framework to be positioned on the structure from a barge, with no need for any operators to work on the structure or on the framework; this ensures optimum safety for the maintenance personnel. Once placed on a floater, the framework is attached to it to avoid any risk of slipping or separation.

Obviously, this third object of the invention is not limited to the examples which have just been described. On the contrary, the invention is defined by the following claims.

It will appear to those skilled in the art that various modifications can be made to the embodiments described above, in reference to FIGS. 25 to 34, in the light of the information that has just been disclosed.

Thus, instead of poles of different heights, housings of different heights can be used, or any other intermediate arrangement, so that one pole can be inserted in its housing before the other pole. Also, the poles can be on the framework and the housings on the structure.

In the following descriptions, the framework has the shape of a beam, with a single main dimension; a framework according to the invention could also have two main dimensions and rest on 3 supports, for example on three different floaters.

Thus, the method is not limited to the platforms described previously. It can be used on other types of platform, in particular semi-submersible platforms: having four floaters and an XCF type central mast, having four floaters and an offset mast, with NOV T type Tri-Floater, or, with two Hexicon turbines. It can also be applied to barges, for example of BW-Ideol type.

In each case, a framework according to the invention can be used to change a blade or components of the nacelle, preferably with a variable distance between the tool used and the mast, to limit the movements in the tower of the hoisting device. In addition, such a framework minimises the reinforcements required for such an operation by resting on pre-existing hard points of the platform.

1-38. (canceled)

39. A method for a maintenance activity of an offshore wind turbine system, in particular to change a blade or handle a load which can be an item of equipment located in a nacelle of said offshore wind turbine system, said method comprising:
identifying said offshore wind turbine system, said offshore wind turbine system including a wind turbine and a platform, said wind turbine comprising a mast and said nacelle being supported by said mast, said nacelle comprising a rotor having a nose and blades which extend radially from said nose;
immobilizing the nacelle and the rotor in a handling position;
supplying a crane or a hoisting device having a mast comprising a plurality of elements of which some can be telescoped relative to each other;
mounting said crane and telescoping said telescopable elements relative to each other;
handling said blade or said load;
dismantling said crane; and
releasing the movements of the nacelle and the rotor.

40. The method according to claim 39, that can be used for replacing a blade, wherein the handling of the blade includes a step of removing an old blade and a step of installing a new blade.

41. The method according to claim 40, wherein in the handling position, the old blade is in a substantially horizontal position.

42. The method according to claim 39, wherein the platform includes means for attaching the crane on the platform.

43. The method according to claim 42, wherein the platform includes at least three floaters connected together by a rigid structure having beams, said rigid structure acting as support for the wind turbine, the means for attaching the crane being arranged at a top of one of said floaters.

44. The method according to claim 39, wherein the crane includes a base to be attached to the wind turbine system.

45. The method according to claim 39, wherein the crane includes hoisting means in order to move the blade horizontally and vertically.

46. The method according to claim 45, wherein the hoisting means includes
a sleeve and a double jib mounted so as to slide horizontally in said sleeve and having two ends each projecting from a respective side of said sleeve, each of said ends having a respective hoist rope,
a spreader bar means, and
at least one cradle on which the blade can rest, while the blade is being implemented.

47. A method for handling at least one load of a wind turbine, said method comprising:
identifying said wind turbine, said wind turbine including a mast rigidly attached to a seabed and a nacelle supported by said mast, said nacelle comprising a rotor having blades which extend radially:
supplying a self-elevating platform;
immobilizing said self-elevating platform near said wind turbine;
mounting a hoisting system on said a self-elevating platform, said hoisting system including a mast that is substantially vertical along an axis of the hoisting system and composed of a plurality of elements and a hoisting tool attached to an upper element;
immobilizing the nacelle in a position allowing said load to be handled;
raising said mast;
gripping said load;
lowering said mast; and
releasing the movements of the nacelle.

48. The method according to claim 47, wherein the hoisting tool is attached substantially at a top of an upper mast element and forms with said mast a “T” shape.

49. The method according to claim 47, wherein the hoisting tool comprises a horizontal beam mounted at a top of the upper element and forming a “T” with this element, a slide mounted so as to slide horizontally on said horizontal beam, this slide supporting seating means, preferably having an adjustable height, provided to rest a blade thereon.

50. The method according to claim 49, wherein the horizontal beam is mounted so as to rotate about the axis of the hoisting system and in that the hoisting tool comprises, at one end of said horizontal beam, a winch means.

51. The method according to claim 47, wherein the hoisting tool comprise a sleeve and a double jib mounted so as to slide horizontally in said sleeve and having two ends each projecting from a respective side of said sleeve, each of said ends having a respective hoist rope.

52. The method according to claim 47, wherein said wind turbine includes a base that is fixed relative to the platform, the mast being mounted so as to rotate on said base about the axis of the system, the hoisting tool comprising a substantially horizontal beam that is rigidly arranged at a top of the upper element, a winch being attached to the lower element such that it rotates about said axis, at the same time as said mast, and, a rope connected to the winch, the system further comprising a first rope return and a second rope return, each one being arranged at a respective end of the horizontal beam such that:
said rope is substantially horizontal between the two returns;
the rope extends vertically between the winch and the first return; and,
a free end of the rope extends past the second return to suspend a load.

53. The method according to claim 47, wherein said wind turbine includes an arm means to connect the mast of the hoisting system with the mast of the wind turbine, preferably at least one arm being slidably mounted on said mast of the wind turbine.

54. A tool for positioning or removing a blade of a wind turbine, the tool comprising a spreader bar and a positioner, the spreader bar being designed to hoist said blade using a crane, the spreader bar and the positioner comprising reciprocal gripping means, the positioner comprising means for attaching it to hoisting means and means for orienting and moving the blade relative to said hoisting means.

55. The tool according to claim 54, wherein the reciprocal gripping means includes reciprocal insertion means and the insertion means includes two poles and sleeves to insert therein rods of which one rod can be inserted before the other.

56. The tool according to claim 54, wherein the spreader bar includes at least one clamp to take the blade, a yard arranged longitudinally, and two clamps each at a respective longitudinal end of said yard, each clamp having a lower jaw and an upper jaw, the lower jaw being fixed relative to the yard and the upper jaw being able to move vertically, such that when the blade rests on the lower jaw, the upper jaw clamps the blade to hold the blade.

57. The tool according to claim 54, wherein the positioner includes means for tilting the blade about a horizontal transverse axis;
means for moving the blade longitudinally; and
at least one of means for moving the blade transversally and means for rotating the blade about a vertical axis.

58. The tool according to claim 54, wherein the positioner includes:
a base on which the spreader bar can be placed, said base comprising means for gripping the positioner on said spreader bar;
a trolley;
a longitudinal guide; and,
a connector;
the longitudinal guide being arranged at an upper end of the connector and connected to the connector by a hinge which allows said longitudinal guide to tilt about a transverse horizontal axis, a tilt actuator being used to control said tilting;
the trolley being mounted so as to slide longitudinally on the longitudinal guide, a longitudinal actuator being used to control a longitudinal translation of said trolley relative to said guide;
the base being mounted so as to slide transversally on the trolley, a transverse actuator being used to control a transverse translation of said base relative to said trolley.
